(19) United States
(12) Patent Application Publication
(10) Pub. No.: US 2025/0004796 A1
(43) Pub. Date: Jan. 2, 2025

(54) USER INTERFACE (UI) SHORTCUTS GENERATED BASED ON CAPTURED WORKFLOW ACTIVITY

(71) Applicant: International Business Machines Corporation, Armonk, NY (US)

(72) Inventors: Zachary A. Silverstein, Georgetown, TX (US); Logan Bailey, Atlanta, GA (US); Suman Patra, Kolkata (IN); Tiberiu Suto, Franklin, NY (US)

(21) Appl. No.: 18/215,053

(22) Filed: Jun. 27, 2023

(51) Int. Cl. G06F 9/451; G06F 9/46

(52) U.S. Cl. CPC G06F 9/451; G06F 9/461

(57) ABSTRACT

A computer-implemented method, according to one embodiment, includes capturing at least one workflow activity input by a user on a first user device, and analyzing the at least one workflow activity to determine whether the at least one workflow activity corresponds to at least one predetermined workflow process. In response to a determination that the at least one workflow activity corresponds to a first of the at least one predetermined workflow process, a first user interface (UI) shortcut to a predicted next workflow activity in the first workflow process is generated. The first UI shortcut is embedded in the first workflow process for display on the first user device. A computer program product, according to one embodiment, includes a computer readable storage medium having program instructions embodied therewith. The program instructions are readable and/or executable by a computer to cause the computer to perform a foregoing method.

### BACKGROUND

The present invention relates to navigation on a user interface (UI), and more specifically, this invention relates to UI shortcuts generated based on captured workflow activity.

User devices, e.g., computers, tablets, cellular phones, display modules, etc., often include a UI that may be navigated via user input to accomplish one or more tasks. In some implementations, the UI includes a display, which may be a touchscreen display, and is referred to as a “graphical user interface” (GUI). User input may be received on the user device as, e.g., touch selections on a touch-sensitive portion of a display of the user device, voice narrations received by a microphone of the user device, selections indicated by a second device (a computer mouse) paired with the user device, etc.

In some use cases, a series of inputs are performed and thereby received as user input of a user who is attempting to accomplish a series of tasks. For example, in order to enter data in an electronically displayed application, a series of data inputs may be received, e.g., a plurality of selections that lead to the UI displaying the application, a name of the applicant being entered into the application, selection of an option to submit the application, etc.

Use of UI such as a GUI allows a user to virtually undertake tasks via a user device. In some use cases, this reduces an amount of paper that would otherwise be consumed to accomplish such tasks, and furthermore, allows for work to be remotely performed on the user device.

### SUMMARY

A computer-implemented method, according to one embodiment, includes capturing at least one workflow activity input by a user on a first user device, and analyzing the at least one workflow activity to determine whether the at least one workflow activity corresponds to at least one predetermined workflow process. In response to a determination that the at least one workflow activity corresponds to a first of the at least one predetermined workflow process, a first user interface (UI) shortcut to a predicted next workflow activity in the first workflow process is generated. The first UI shortcut is embedded in the first workflow process for display on the first user device.

A computer program product, according to one embodiment, includes a computer readable storage medium having program instructions embodied therewith. The program instructions are readable and/or executable by a computer to cause the computer to perform a foregoing method.

A system, according to one embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is an operational flowchart, in accordance with one embodiment of the present invention.

FIG. 4 is an operational flowchart, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for generating user interface (UI) shortcuts based on captured workflow activity.

In one general embodiment, a computer-implemented method includes capturing at least one workflow activity input by a user on a first user device, and analyzing the at least one workflow activity to determine whether the at least one workflow activity corresponds to at least one predetermined workflow process. In response to a determination that the at least one workflow activity corresponds to a first of the at least one predetermined workflow process, a first user interface (UI) shortcut to a predicted next workflow activity in the first workflow process is generated. The first UI shortcut is embedded in the first workflow process for display on the first user device.

In another general embodiment, a computer program product includes a computer readable storage medium having program instructions embodied therewith. The program instructions are readable and/or executable by a computer to cause the computer to perform a foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as user interface (UI) shortcut generating code of block 150 for generating UI shortcuts based on captured workflow activity. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

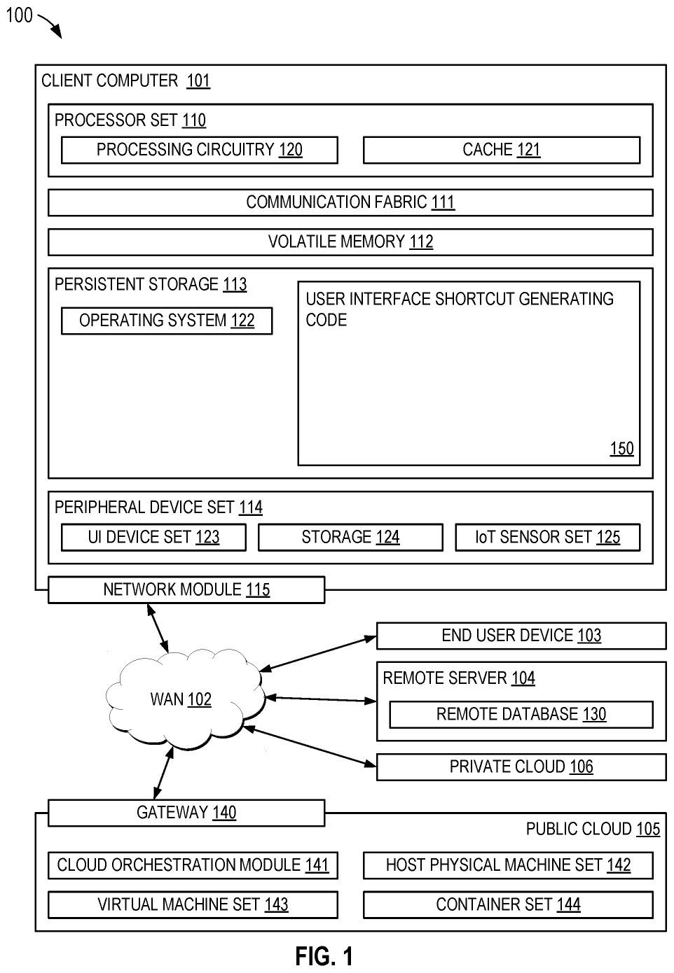

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, user devices, e.g., computers, tablets, cellular phones, display modules, etc., often include a UI that may be navigated via user input to accomplish one or more tasks. In some implementations, the UI includes a display, which may be a touchscreen display, and is referred to as a “graphical user interface” (GUI). User input may be received on the user device as, e.g., touch selections on a touch-sensitive portion of a display of the user device, voice narrations received by a microphone of the user device, selections indicated by a second device (a computer mouse) paired with the user device, etc.

In some use cases, a series of inputs are performed and thereby received as user input of a user who is attempting to accomplish a series of tasks. For example, in order to enter data in an electronically displayed application, a series of data inputs may be received, e.g., a plurality of selections that lead to the UI displaying the application, a name of the applicant being entered into the application, selection of an option to submit the application, etc.

Use of UI such as a GUI allows a user to virtually undertake tasks via a user device. In some use cases, this reduces an amount of paper that would otherwise be consumed to accomplish such tasks, and furthermore, allows for work to be remotely performed on the user device.

As a user performs activities, e.g., selection of a selectable tab on a GUI of a user device, text entry, voice entry, etc., these activities may define a “multistep workflow” that is defined by two or more user actions. In a multistep workflow, users often must navigate to and from applications or webpages to collect and input data or perform required tasks. For example, each time that a loan officer of a bank wants to open an application for a new client, the loan officer is forced to navigate to an application template, and virtually navigate the application pages to manually enter a series of data entries. Efficiency may be hindered by the user having to manually key or perform multiple inputs to navigate through this multistep workflow. Specifically, there is a longstanding need to reduce the processing operations that computers perform in repetitive multistep workflows.

In sharp contrast to the deficiencies of the conventional techniques described above, the embodiments and approaches described herein include techniques for optimizing user navigation during a detected workflow process based on dynamically embedding a user interface shortcut. Specifically, these techniques include automatically deriving a workflow in process and providing assistance in the form of embedded UI shortcuts for the user. As will be described in further detail below, these UI shortcuts streamline multistep workflows performed on a computer by efficiently reducing the amount of processing operations that are performed on a user device in the process of completing a multistep workflow.

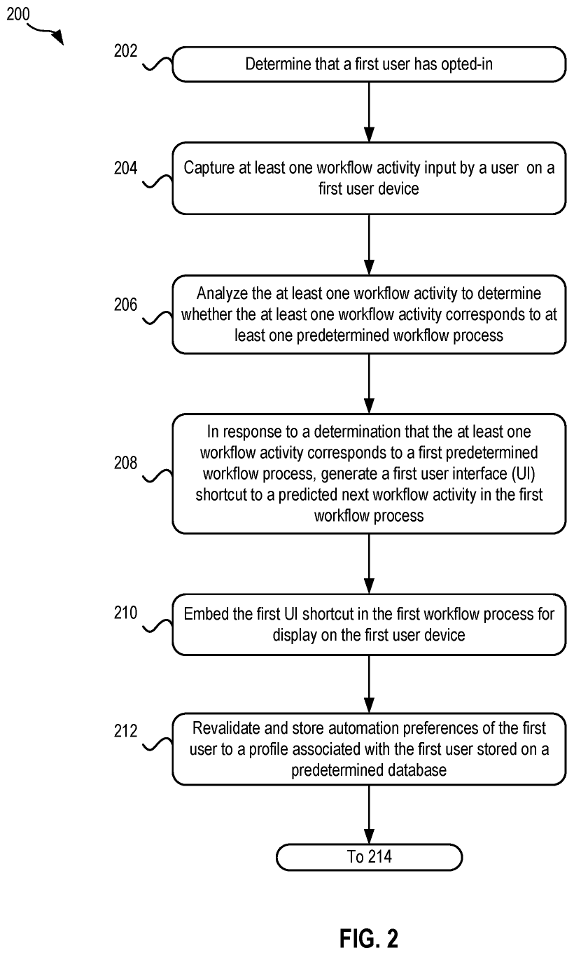

Now referring to FIG. 2, a flowchart of a method 200 is shown according to one embodiment. The method 200 may be performed in accordance with the present invention in any of the environments depicted in FIGS. 1-4, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It should be noted that various embodiments and approaches described herein monitor user actions performed on user devices and/or use data associated with user actions performed on user devices. In embodiments and approaches described herein, any monitoring and use of such data is preferably only obtained and used subsequent to a user granting permission to be monitored and their data to be used, e.g., an opt-in clause, registering for a service, etc. More specifically, this permission is preferably obtained in such a way that the user has the opportunity to consider and review details of how their information will be used (to assist the user in making an informed decision), and is thereafter presented with an option to opt-in, e.g., an expressly performed opt-in selection. Thereafter, the user is preferably reminded of their opt-in, and ongoingly presented with features, e.g., output for display on a user device associated with the user, that relatively easily allow the user to retract their previous election to opt-in. For example, operation 202 of method 200 includes determining that a first user has opted-in to a service associated with the operations of method 200. For example, in some approaches, a determination may be made that the first user opted-in to a service of a module that tracks and monitors inputs associated with the first user's use of a first user device.

With permission gained to monitor user actions performed by the first user on at least a first user device and/or to use data associated with the first user, in some approaches, the method optionally proceeds to operation 204. Operation 204 includes capturing at least one workflow activity input by a user on a first user device. In some approaches, the module that tracks and monitors inputs associated with the first user's use of a first user device may be a monitoring module of a type that would become apparent to one of ordinary skill in the art after reading the descriptions herein. In some approaches, the module may be configured to track and build a unique corpus for each individual user of a plurality of registered users. The module may, in some approaches, consider widgets, applications, domains and pages that the user navigates on and/or to, etc. In some other approaches, such a module may additionally and/or alternatively be a known type of business process model and notation (BPMN) model. The module may, in some approaches, be deployed on one or more processors, which may be in communication with (receive information from) and/or connected to the first device. In some approaches, the module is caused, e.g., instructed, and/or configured to capture user behavior and input associated with the first device to learn a user's workflow process via a task mining agent deployed on first user device. Accordingly, in some approaches, the capturing may include causing, e.g., instructing, a task mining agent to be executed on the first user device. For context, in some approaches, the task mining agent may be deployed on the first user device to ongoingly track and record workflow activities performed on the first user device. Information mined by the task mining agent may be added to a predetermined database.

In some approaches, the module is caused, e.g., instructed, and/or configured to capture user behavior and input associated with the first device to contextualize the workflow activity inputs. This contextualizing may include determining whether at least one of the workflow activities correspond to a predetermined user workflow process. For example, method 200 may include analyzing the at least one workflow activity to determine whether the at least one workflow activity corresponds to at least one predetermined workflow process, e.g., see operation 206. In some approaches, the information mined by the text mining agent may establish a corpus of the behavior of workflow activities that the analysis of operation 206 is based on, e.g., where the corpus is used as an input to a predetermined analysis engine. In some approaches, this input is an automation script that is based on a recording of the task mining agent.

In some approaches, the captured workflow activity input may be analyzed to identify and distinguish relatively frequently performed workflow activities that make up a workflow process, from other relatively infrequently performed workflow activities that do not make up a workflow process (based on being performed less than a predetermined threshold number of times). In other words, in some approaches, user activity patterns may be learned and contextualized to one or more workflow processes. In some approaches, after each stage and/or task assignment, e.g., capturing of at least one workflow activity, the task mining agent may be activated. Machine-learning algorithms combined with optical character recognition (OCR) and natural language processing (NLP) may, in some approaches, be used to mine tasks, after collecting and understanding actions that users perform on user devices such as a desktop. This information may be used to identify and define patterns of workflow activities that establish workflow processes. For example, workflow activities that impact business outcomes relatively often, e.g., at least once every predetermined number of times that they are performed, may be determined to make up a first established workflow process. As previously mentioned elsewhere above, the analysis may, in some approaches, include machine learning. For example, the analysis may include executing a type of machine learning process that would become apparent to one of ordinary skill in the art after reading the descriptions herein. Execution of the machine learning process may, in some approaches, result in a module learning at least some predetermined workflow processes, and thereafter determining whether the captured workflow activities follow, e.g., match, any of the predetermined workflow processes. In some other approaches, the analysis may additionally and/or alternatively include optical character recognition (OCR). In one or more of such approaches, the OCR may determine whether contents of search bar and/or domain page contents displayed on the first user device match the contents of at least one of the workflow activities of at least one of the predetermined workflow processes. In yet some other approaches, the analysis may additionally and/or alternatively include natural language processing (NLP). In one or more of such approaches, the NLP may be used to determine whether language contents of each of the captured workflow activities match predetermined language contents of at least one of the predetermined workflow processes.

In some approaches, the analysis may include determining whether at least a predetermined number of workflow activities match the workflow activities that make up a predetermined workflow process. For example, it may be assumed that a first predetermined workflow process includes ten workflow activities, and in response to a determination that the captured workflow activity includes at least a predetermined threshold number of the ten workflow activities, a determination may be made that the captured workflow activity corresponds to the first workflow process. In contrast, in response to a determination that the captured workflow activity does not include at least the predetermined threshold number of the ten workflow activities, a determination may be made that the captured workflow activity corresponds to the first workflow process. In some other approaches, in order for a determination to be made that the captured workflow activity corresponds to the first workflow process, each of the captured workflow activities may, in some approaches, need to be performed in a predetermined sequential order (with no intervening workflow activities that are not part of the predetermined sequential order being performed between any of the sequential workflow activities of the predetermined sequential order).

In some use cases, the captured workflow activities may include a plurality of workflow activities, e.g., a majority of the workflow activities, at least one of the workflow activities, all of the workflow activities, etc., that match at least one predetermined workflow process, e.g., where the predetermined workflow process may include a predetermined sequence of workflow activities. In some approaches described herein, captured workflow activities that match at least one of the predetermined workflow processes may be referred to as “tasks internal to a context” of at least a first of the predetermined workflow process used in the determination. In other words, each of the captured workflow activities identified by the task mining agent, that are determined to match the workflow activities of a predetermined workflow process may be determined to satisfy tasks internal to at least a first context of at least the workflow process. However, in some use cases, a determination may be additionally and/or alternatively made that one or more of the workflow activities do not match at least one predetermined workflow process. In some approaches, workflow activities that do not match at least one predetermined workflow process may be referred to as “tasks external to a context” of at least a first of the predetermined workflow processes used in the determination. In other words, each of the captured workflow activities identified by the task mining agent, that are determined to not match the workflow activities of a predetermined workflow process may be determined to not satisfy tasks internal to at least a first context of at least the first workflow process, and therefore may be categorized as workflow activities that correspond to “external” tasks. Accordingly, the task mining agent may be caused, e.g., instructed, to identify tasks internal to a context of at least the first workflow process and/or tasks external to the context of at least the first workflow process.

The task mining agent may additionally and/or alternatively be caused, e.g., instructed, to determine whether a captured workflow activity corresponds to an internal task or an external task based on a relationship of the workflow activity with respect to a predetermined page, e.g., a webpage displayed on the first user device at a time that the given workflow activity is performed. For example, in some approaches, workflow activities that include text entry and/or processing that matches text on a webpage displayed on the first user device at a time that the given workflow activity is performed may be identified as tasks internal to a context of at least a first of the predetermined workflow processes, e.g., within a context of the page. In contrast, workflow activities that include text entry and/or processing that does not match text on the webpage displayed on the first user device at the time that the given workflow activity is performed may be identified as tasks external to the context of at least the first of the predetermined workflow processes, e.g., outside of the context of the page.

In order to relatively improve performance of a processing circuit that processes input/output (I/O) operations of the workflow activities, e.g., the first user device, a server in communication with the first device to fulfill access requests from the first device, etc., and furthermore to reduce network traffic associated with performing the workflow activities of the first workflow process, in some approaches, UI shortcuts may be selectively generated and made available. For example, in some preferred approaches, in response to a determination, based on results of the analysis, that the at least one workflow activity corresponds to a first of the at least one predetermined workflow process, a first UI shortcut may be generated, e.g., see operation 208. For context, the first UI shortcut may be a selectable shortcut, e.g., configured to be selected by a click on a touch-sensitive portion of the display of the first device when displayed thereon, that when selected, results in at least one of the workflow activities of the workflow process to be skipped. For example, it may be assumed that the first predetermined workflow process includes ten workflow activities and that performance of the tenth workflow activity causes a predetermined result to occur, e.g., a calculated output to be presented on the display of the first device, the first device being caused to display a predetermined webpage, access being provided to data of a predetermined database, etc. It may also be assumed that a determination is made based on captured workflow activity that a first four of the ten workflow activities have been performed, and therefore the first UI shortcut is caused to be displayed on the display of the first user device. In response to a determination that the first UI shortcut has been selected, method 200 may include bypassing a remaining portion of the ten workflow activities, i.e., workflow activities five through ten via a generated shortcut path associated with the UI shortcut, that have not been performed, and causing the predetermined result to occur as if the remaining portion of the ten workflow activities were performed.

Although approaches above describe that the first UI shortcut is configured to cause a remaining portion of the ten workflow activities to be bypassed, in some other approaches, the first UI shortcut may be configured as a shortcut to a predicted subsequent, e.g., such as a next, workflow activity in the first workflow process. For example, assuming that the first four workflow activities of the first workflow process are determined to have been performed, the first UI shortcut may be configured as a shortcut to the fifth workflow activity, e.g., based on a prediction that the fifth workflow activity would be performed next by the user on the first user device. In some other approaches, the last of the ten workflow activities may be predicted as the next workflow activity. For context, in some approaches, based on at least a determination that at least a predetermined number of the workflow activities have been performed, a predication may be made that the user is performing the first workflow process. Accordingly, in one or more of such approaches, the predicted next workflow activity may be the last workflow activity of the workflow process, e.g., the tenth workflow activity.

In some other approaches, the first UI shortcut may be configured as a shortcut to a predicted external task associated with the first workflow process. For example, in some approaches, in response to a determination that at least one of the captured external workflow activities does not correspond to the first workflow process, the first UI shortcut may be configured as a shortcut to a predicted external task associated with the first workflow process, where the UI shortcut would otherwise be configured as a different configuration of shortcut in response to a determination that all of the captured external workflow activities corresponded to the first workflow process. The external task may, in some approaches, be based on the workflow activity that does not correspond to the first workflow process. For example, assuming that the first workflow process includes a plurality of related workflow activities for filling out an application on the first user device, the captured workflow activity that does not correspond to the first workflow process may include checking a weather report. In such an approach, the first UI shortcut may be configured to, thereafter if selected, cause the application to be filled out with an identified collection data associated with an applicant and a weather forecast for at least one previously searched location to be displayed on the display of the user device. In other words, the weather forecast feature is added to the UI shortcut in response to a determination that the captured workflow activities include the external workflow activity, and the UI shortcut would otherwise only include the application completion feature if the captured workflow activities included only the plurality of related workflow activities associated with filling out the application on the first user device.

The first UI shortcut may, in some other approaches, be generated as a bookmark configured to cause the first workflow process to resume in response to a determination that the first user has abandoned the first workflow process. In some use cases, a user who has performed one or more of the workflow activities of the first workflow process may become temporarily sidetracked and perform one or more workflow activities that do not correspond to the first workflow process. For example, assuming that the first workflow process includes a plurality of workflow activities for filling out an application, at least some of the captured workflow activities may be based on the first user replying to an email while in the process of completing the application. In such an example, the user may intend to complete the application after replying to the email, and therefore, in some approaches, processing resources of the first device may be preserved by generating a UI shortcut that is configured to optionally cause, e.g., in the event that the UI shortcut is selected, the first workflow process to resume rather than deleting the partially filled out application in response to a determination that the first user has abandoned the first workflow process. Accordingly, in some approaches, the UI shortcut may be generated in response to a determination that the first user has deviated from the first workflow process, to allow the first user to “temporarily” abandon the first workflow process and thereafter easily return to the first workflow process by selecting the UI shortcut. In order to resume the first workflow process the UI shortcut may be configured to, in the event that the UI shortcut is selected, cause the partially completed application to be again displayed in the display of the first device and/or a remaining portion of unanswered application questions to be automatically populated with determined answers. Additional factors that may be used for the determination that the first user has abandoned the first workflow process may, additionally and/or alternatively, be based on detection of a predetermined condition being met. For example, the predetermined condition may include, e.g., a predetermined amount of time passing, at least a predetermined number of workflow activities that do not correspond to the first workflow process being performed by the first user, the user entering text into a search bar that is determined to not have at least a predetermined threshold degree of similarity with workflow activities already performed, etc. In some other approaches, the predetermined condition may include the first device being placed in a suspended state, e.g., a sleep mode, entering an update process, restarting, etc.

The first UI shortcut may, in some approaches, be added to a predetermined list of temporary bookmarks that are each based on allowing continuation of a different unfinished workflow activity of a workflow process. The predetermined list of bookmarks may be “temporary” in that they are dynamically updated over time. For example, in response to a determination that a predetermined amount of time has passed without the bookmark being used, the bookmark may be cleared from the predetermined list. In some other approaches, the predetermined list may include a predetermined number of slots for bookmarks that is dynamically adjusted to include bookmarks that are used relatively most often, e.g., based on a heat-map that tracks bookmark usage, based on consideration of which of the workflow processes are being performed relatively most often, etc. In some other approaches, the predetermined list of temporary bookmarks may be adjusted based on user input/preferences that may be received from the first device, a device used by an administrator, etc. In one use case scenario, a determination may be made that the first user begins performing a secondary workflow activity that is not included in the first workflow process, prior to completing a typically performed workflow process. In response thereto, the module may be caused, e.g., instructed, to generate a relatively less invasive shortcut to allow the first user to quickly hop back in the workflow process where they left off upon performing the secondary workflow activity.

In some approaches, the first UI shortcut may be generated based on a continuous bag of words model (CBOW) and/or a skip-gram model. For example, one or more of such models may be used for predicting the next step and context of the workflow, and the predicted next step may be used as a destination and/or result that selection of the first UI shortcut leads to and/or causes to occur.

Operation 210 includes embedding the first UI shortcut in the first workflow process for display on the first user device. In some approaches, the UI shortcut is generated as a widget that is, during an event, attached and associated to a client-side of the first user device and linked to a custom attended automation that co-habitates on the first user device. In some approaches, the UI shortcut is an icon that may be clicked. In some other approaches, the UI shortcut is a list, e.g., such as a dropdown list that includes a plurality of predicted next workflow activities, destinations, results and/or external tasks. For example, in some approaches, the list includes a plurality of these predicted contents, and the list may be ordered, e.g., from a relatively highest prediction confidence score to a relatively lowest prediction confidence score. Such confidence scores may be determined using techniques that would become apparent to one of ordinary skill in the art after reading the descriptions herein. This event may be passed by either an extension or webhooks from the site itself. In webhooks, a hypertext transfer protocol (HTTP) request is triggered by an event in one system and sent to the other system with data in the payload. An automated webhook is sent out when an event in the source system occurs. In some approaches, these techniques may be used to cause the first UI shortcut to be made available on the first user device.

In some other approaches, embedding the first UI shortcut in the first workflow process includes adding the first UI shortcut in a predetermined portion of a display of the first user device that at least one of the captured workflow activities was input on. In another approach, embedding the first UI shortcut in the first workflow process may include modifying computer code to be configured to output the first UI shortcut in response to a next determination that at least one workflow activity that corresponds to the first workflow process is performed. This approach may be particularly relevant to cases in which the first workflow process is initially learned, e.g., such as where the information mined by the text mining agent is initially used to establish a corpus of the behavior of workflow activities that correspond to the first workflow process.

Operation 212 includes revalidating and storing automation preferences of the first user to a profile associated with the first user stored on a predetermined database. This profile may be fetched in order to analyze captured workflow activities, in some approaches. In some approaches, revalidating the preferences of the first user may include adding to a count stored on the predetermined database that reflects a number of times that the generated UI shortcut is selected. In other words, in response to a determination that the generated UI shortcut is selected, an accuracy of the model may be confirmed by adding to the count. In contrast, in response to a determination that the generated UI shortcut is not selected, the count may be subtracted from, e.g., minus one, to indicate that the generated UI shortcut was not accurate. In response to a determination that the count falls below a predetermined threshold, a predetermined corrective action may be performed, e.g., a query for updated user preferences may be output to the first device, a number of the workflow activities of a given one of the workflow processes that must be detected before the UI shortcut is generated may be increased, the number of options on a list of a UI shortcut may be increased to diversify the options available to the first user, etc.

Because the activities performed by a user may change over time and/or adapt based on the UI shortcuts generated and made available to the user, in some approaches, the tasks external to the context of at least the first workflow process may be used to build a corpus of second workflow activities for widgets, applications, and pages, outside a current context of the first workflow process. For example, in one or more of such approaches, external workflow activities may themselves be used to establish a new corpus and/or workflow processes that is thereafter monitored for. For example, in some approaches, in response to a determination that a series of workflow activities have been performed within a predetermined amount of time of one another and/or at least a predetermined amount of times, the workflow activities may be associated with a determined second workflow process that the workflow activities thereafter correspond to. Accordingly, monitoring may be performed for additional workflow activities.

Operation 214 includes capturing additional workflow activities input by the user on the first user device. In some approaches, the additional workflow activities may be analyzed to determine whether the second workflow activities correspond to a determined second predetermined workflow process. Operation 216 includes analyzing the additional workflow activities to determine whether the additional workflow activities correspond to at least one predetermined workflow process. Note that, techniques similar to those described above for analyzing the at least one workflow activity may be used to analyze the additional workflow activities.

In response to a determination, from results of the analysis performed on the additional workflow activities, that the additional workflow activities correspond to the second predetermined workflow process, a second UI shortcut may be generated to a predicted next workflow activity in the second workflow process, e.g., see operation 218. Such a determination may be based on whether the additional workflow activities are determined to accomplish tasks internal to a context of a second workflow process and external to a context of the first workflow process. The second UI shortcut may be embedded in the second workflow process for display on the first user device, e.g., see operation 220. Operation 222 includes revalidating and storing automation preferences of the first user to the profile associated with the first user.

It should be noted that, although various of the operations above are described to be performed with respect to at least the first user device, the information captured and used herein may be determined from a plurality of devices used by the first user in some other approaches. Furthermore, in some approaches, method 200 may additionally and/or alternatively be performed for a plurality of users that use one or more of the user devices.

There are several distinguishable benefits enabled as a result of implementing the techniques described herein in an environment that includes user devices. For example, these novel techniques improve workflow process efficiency of navigating through multiple applications or webpages. In other words, as a direct result of recurringly performed activities being identified and incorporated into workflow processes having a corresponding UI shortcut, an amount of I/O is processed on user devices is reduced. This is because I/O operational processing that would otherwise be performed in the workflow activities that are bypassed as a result of use of the UI shortcuts is eliminated. Accordingly, by relatively reducing the processing operations that a user device and/or servers would otherwise perform in repetitive multistep workflows, processing potential of user device and/or servers is preserved.

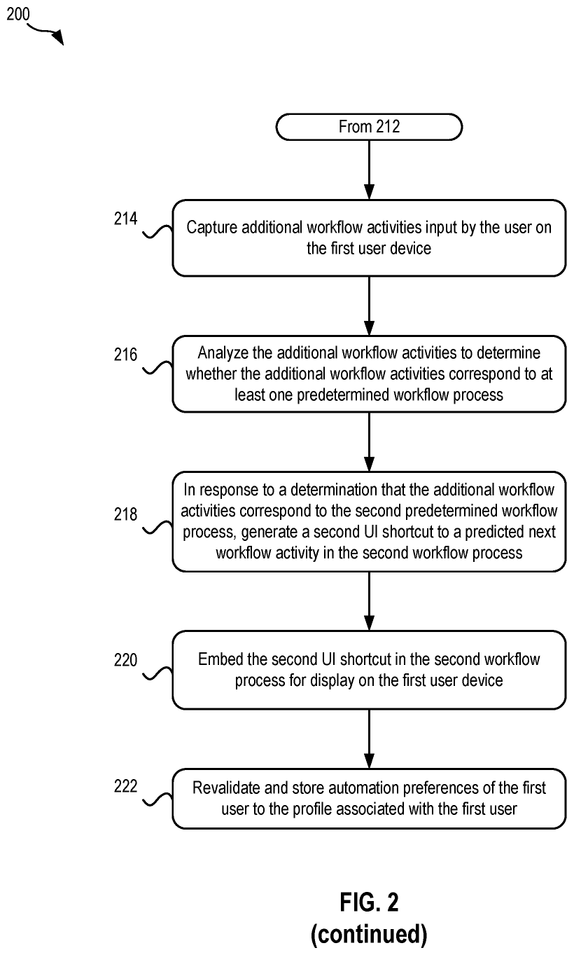

FIG. 3 depicts an operational flowchart 300, in accordance with one embodiment. As an option, the present operational flowchart 300 may be implemented in conjunction with features from any other embodiment listed herein, such as those described with reference to the other FIGS. Of course, however, such operational flowchart 300 and others presented herein may be used in various applications and/or in permutations which may or may not be specifically described in the illustrative embodiments listed herein. Further, the operational flowchart 300 presented herein may be used in any desired environment.

The operational flowchart 300 illustrates a CBOW model that may be used to generate a UI shortcut. In an input phase 302 of the operational flowchart 300, a plurality of input metrics 308, 310, 312 and 314 are considered. These input metrics may include information captured by a task mining agent that is deployed on a user device and is configured to capture one or more workflow activities input on the user device. In a projection phase 304 of the operational flowchart 300, the input metrics are summed to a sum metric 316 using CBOW techniques that would become apparent to one of ordinary skill in the art after reading the descriptions herein. In an output phase 306 of the operational flowchart 300, an output metric 318 is generated based on the sum metric. In some approaches, the output metric 318 is a UI shortcut that is generated based on a determination that captured workflow activities correspond to a predetermined workflow process.

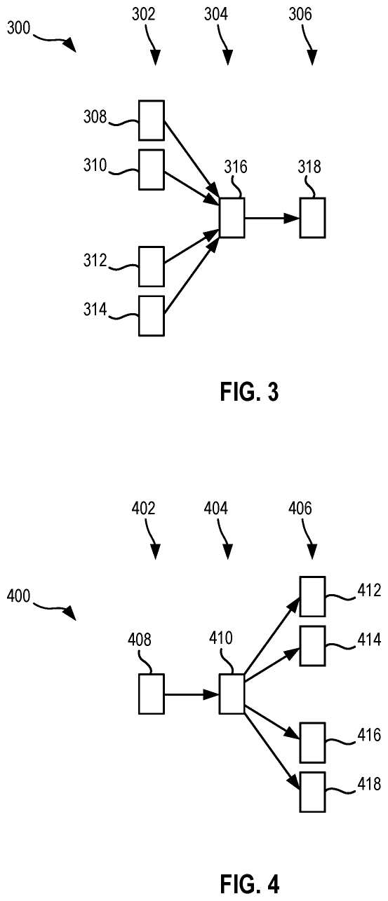

FIG. 4 depicts an operational flowchart 400, in accordance with one embodiment. As an option, the present operational flowchart 400 may be implemented in conjunction with features from any other embodiment listed herein, such as those described with reference to the other FIGS. Of course, however, such operational flowchart 400 and others presented herein may be used in various applications and/or in permutations which may or may not be specifically described in the illustrative embodiments listed herein. Further, the operational flowchart 400 presented herein may be used in any desired environment.

In an input phase 402 of the operational flowchart 400, a single input metric 408 is considered. This input metrics may include information captured by a task mining agent that is deployed on a user device and is configured to capture one or more workflow activities input on the user device. In a projection phase 404 of the operational flowchart 400, the input metric is projected to a projection metric 410 using skip-gram model techniques that would become apparent to one of ordinary skill in the art after reading the descriptions herein. In an output phase 406 of the operational flowchart 400, a plurality of output metrics 412, 414, 416 and 418 are generated based on the projection metric. In some approaches, the output metrics are options of a UI shortcut that is a list of projected next workflow activities of a workflow process that captured workflow activities are determined to correspond to.

Various illustrative use cases for the techniques described herein are described in detail below.

In a first user case, it may be assumed that a first user works as a financial analyst, and that the first user often utilizes a common workflow method when compiling data for a report. The module described herein may be configured to detect the first user's relatively frequent patterns and identify and/or determine a first workflow process. The first workflow process may be stored to a predetermined database. Thereafter, in response to a determination that workflow activities of the workflow process are being performed on a first user device used by the first user, the first user device may be provided with one or more embedded links that, when selected, facilitate rapid transition to a predicted next application or website.

In another use case, the first user may, at least temporarily, stop performing workflow activities of the first workflow process. For example, the first user may web search a specific item that the first user notices in their data. While looking for this information, a UI shortcut that is configured to, when selected, cause a display of the first device to be navigated back to presume a workflow activity, may be output for display on the first user device.

In yet another use case, the first user may relatively often web search “<Company Name> SEC Filings” as a step in a workflow process. The module described herein may be caused, e.g., instructed to capture the company name for generation of a shortcut returning the search engine data that the first user is determined to typically search for.

In another use case, the first user may be a banking analyst, and each time that the first user validates and approves a new customer for a loan, the first user has to take anti-money laundering (AML) actions and research. Task mining may associate the first user's personal workflow process to the first user opening up the loan application, copying the requestor's social security number (SSN) obtained via the requestor's permission, and using an AML lookup tool based on the SSN. The module described herein may be caused to detect that a source invocation point is the loan application and generate a UI widget in response thereto. For context, the source invocation point may be the one of the workflow activities of a predetermined workflow process that the workflow process is recognized by, e.g., a predetermined “nth” workflow activity of the predetermined workflow. After multiple iterations, the UI widget is connected to a known type of robotic process automation robot that is caused, e.g., instructed, to trigger a brief task or workflow automation to copy and execute the AML tasks. In response to a determination that the first user confirms this task, e.g., on a local version of the application on the first user device, a UI shortcut widget may be caused to appear to take this action. On a second user's user device, however, the AML lookup may be performed through a spreadsheet, and a widget presented on the second user device may link to actions of the spreadsheet.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
capturing at least one workflow activity input by a user on a first user device;
analyzing the at least one workflow activity to determine whether the at least one workflow activity corresponds to at least one predetermined workflow process;
in response to a determination that the at least one workflow activity corresponds to a first of the at least one predetermined workflow process, generating a first user interface (UI) shortcut to a predicted next workflow activity in the first workflow process; and
embedding the first UI shortcut in the first workflow process for display on the first user device.

2. The computer-implemented method of claim 1, wherein the analysis is selected from the group consisting of: machine learning, optical character recognition (OCR) and natural language processing (NLP).

3. The computer-implemented method of claim 1, wherein the capturing includes causing a task mining agent to be executed on the first user device.

4. The computer-implemented method of claim 3, wherein the task mining agent identifies tasks internal to a context of at least the first workflow process and tasks external to the context of at least the first workflow process.

5. The computer-implemented method of claim 4, comprising: using the tasks external to the context of at least the first workflow process to build a corpus of second workflow activities for widgets, applications, and pages, outside a current context of the first workflow process, wherein the second workflow activities correspond to a determined second predetermined workflow process; capturing additional workflow activities input by the user on the first user device; analyzing the additional workflow activities to determine whether the additional workflow activities correspond to at least one predetermined workflow process; in response to a determination that the additional workflow activities correspond to the second predetermined workflow process, generating a second UI shortcut to a predicted next workflow activity in the second workflow process; and embedding the second UI shortcut in the second workflow process for display on the first user device.

6. The computer-implemented method of claim 1, wherein the first UI shortcut is generated based on a continuous bag of words (CBOW) model or a skip-gram model.

7. The computer-implemented method of claim 1, wherein the first UI shortcut is generated as a bookmark configured to cause the first workflow process to resume in response to a determination that the first user has abandoned the first workflow process.

8. The computer-implemented method of claim 7, wherein the determination that the first user has abandoned the first workflow process is based on detection of a predetermined condition being met, wherein the predetermined condition is selected from the group consisting of: a predetermined amount of time passing, at least a predetermined number of workflow activities that do not correspond to the first workflow process being performed, and the first device being placed in a suspended state.

9. The computer-implemented method of claim 7, wherein the first UI shortcut is added to a predetermined list of temporary bookmarks that are each based on allowing continuation of a different unfinished workflow activity of a workflow process.

10. A computer program product, the computer program product comprising a computer readable storage medium having program instructions embodied therewith, the program instructions readable and/or executable by a computer to cause the computer to:
capture at least one workflow activity input by a user on a first user device;
analyze the at least one workflow activity to determine whether the at least one workflow activity corresponds to at least one predetermined workflow process;
in response to a determination that the at least one workflow activity corresponds to a first of the at least one predetermined workflow process, generate a first user interface (UI) shortcut to a predicted next workflow activity in the first workflow process; and
embed the first UI shortcut in the first workflow process for display on the first user device.

11. The computer program product of claim 10, wherein the analysis is selected from the group consisting of: machine learning, optical character recognition (OCR) and natural language processing (NLP).

12. The computer program product of claim 10, wherein the capturing includes causing a task mining agent to be executed on the first user device.

13. The computer program product of claim 12, wherein the task mining agent identifies tasks internal to a context of at least the first workflow process and tasks external to the context of at least the first workflow process.

14. The computer program product of claim 13, the program instructions readable and/or executable by the computer to cause the computer to: use the tasks external to the context of at least the first workflow process to build a corpus of second workflow activities for widgets, applications, and pages, outside a current context of the first workflow process, wherein the second workflow activities correspond to a determined second predetermined workflow process; capture additional workflow activities input by the user on the first user device; analyze the additional workflow activities to determine whether the additional workflow activities correspond to at least one predetermined workflow process; in response to a determination that the additional workflow activities correspond to the second predetermined workflow process, generate a second UI shortcut to a predicted next workflow activity in the second workflow process; and embed the second UI shortcut in the second workflow process for display on the first user device.

15. The computer program product of claim 10, wherein the first UI shortcut is generated based on a continuous bag of words (CBOW) model or a skip-gram model.

16. The computer program product of claim 10, wherein the first UI shortcut is generated as a bookmark configured to cause the first workflow process to resume in response to a determination that the first user has abandoned the first workflow process.

17. The computer program product of claim 16, wherein the determination that the first user has abandoned the first workflow process is based on detection of a predetermined condition being met, wherein the predetermined condition is selected from the group consisting of: a predetermined amount of time passing, at least a predetermined number of workflow activities that do not correspond to the first workflow process being performed, and the first device being placed in a suspended state.

18. The computer program product of claim 16, wherein the first UI shortcut is added to a predetermined list of temporary bookmarks that are each based on allowing continuation of a different unfinished workflow activity of a workflow process.

19. A system, comprising:
a processor; and
logic integrated with the processor, executable by the processor, or integrated with and executable by the processor, the logic being configured to:
capture at least one workflow activity input by a user on a first user device;
analyze the at least one workflow activity to determine whether the at least one workflow activity corresponds to at least one predetermined workflow process;
in response to a determination that the at least one workflow activity corresponds to a first of the at least one predetermined workflow process, generate a first user interface (UI) shortcut to a predicted next workflow activity in the first workflow process; and
embed the first UI shortcut in the first workflow process for display on the first user device.

20. The system of claim 19, wherein the analysis is selected from the group consisting of: machine learning, optical character recognition (OCR) and natural language processing (NLP).
